(19) United States
(12) Patent Application Publication
(10) Pub. No.: US 2012/0221379 A1
(43) Pub. Date: Aug. 30, 2012

(54) FACILITY CONTROL SYSTEM (FCS) TO MANAGE ASSETS AND PRODUCTS

(76) Inventors: David Frederick Martinez, Houston, TX (US); Nainesh Vora, Houston, TX (US); Elias George ElDabdah, Houston, TX (US); Chuang-Tsair Shih, Houston, TX (US)

(21) Appl. No.: 13/025,211

(22) Filed: Feb. 11, 2011

(51) Int. Cl. G06Q 10/06

(52) U.S. Cl. 705/7.37

(57) ABSTRACT

A facility control system includes lab, field and construction equipment with a wireless transceiver to transmit machine generated actual initial measurement (AIM) data from a field test to a wide area network; a mobile computer with a wireless transceiver to transmit human generated data from an office, a remote lab, or a field test to the network; and a server coupled to the network, the server including a database to receive machine and human generated AIM data, wherein the server applies statistics and engineering methods to predict specification compliance and performance, wherein the AIM data is used with pre formatted engineered designed data sheets that reflect the exact location of the event and required standards including incorporating best construction practices for installation of one or more construction items and materials quality to promote standardization, uniformity that insures contract compliance and minimizes non-conforming items, wherein the AIM and AFM data is determined on the server over the network in real time, wherein the server, lab equipment, and mobile computer form a systematic approach to provide real time dynamic reports regarding one or more components of a capital improvement program (CIP); wherein the systematic approach enables one or more construction teams to generate dynamic reports in real time with best practice engineered designed data sheets for installation and testing of project activities and construction items, and wherein the systematic approach supports indexing of complete project specific data to facilitate document retrieval and project collaboration.

This systematic approach provides an efficient novel approach for managing one project and or a program and/or portfolio that includes a plurality of projects that and facilitate the rollup. The invention also enable independent projects to be manage in real time and allow the rollup of the independent projects that comprise a portfolio.

### BACKGROUND

Historically owners/agencies and parts of the management team have been responsible for managing large capital programs from the conceptual, planning, design, construction, operation and maintenance. These programs include horizontal and vertical facilities, ranging from roads, bridges, water lines, sewer lines, overlays, sidewalks to variety of building including office buildings. Program managers were unable to determine the “true” real time status of the life cycles of each component in the capital improvement program (CIP). Project managers have relied on untimely, invalidated and incorrect information to manage engineering and construction programs. The use of incomplete and inaccurate static data sheets and information that is dated has been the norm in managing projects for the last 200 years. A long term need was to secure real time accurate validated and formatted in best practices review reports information from the entire program management and various construction teams, including field personnel that can assist in the daily decisions that are needed to control the work, cost, schedule and quality as well administrative reporting requirements for each component of the CIP.

U.S. Pat. No. 6,499,054 to Hesselink et al. discloses a method and system for enabling multiple users from different physical locations to access, observe, control and manipulate physical processes and devices over a computer network such as the Internet. A user may visually monitor the physical set up and state of an experiment or environment by receiving live video and data, as well as directly control instrumentation while receiving live feedback regarding the input commands. Measurement data may be collected into a database and computational analysis can be generated and displayed as a physical process is being performed. An online interactive laboratory notebook is also provided that manages items such as collected data, laboratory parameters, “to do” lists, personal notes, etc.

U.S. Pat. No. 6,687,559 to Radjy et al. discloses a system and method for a vertically integrated construction business. Radjy discloses a system and method for employing the World Wide Web in a business that vertically integrates the concrete materials procurement, specification, submittals, quotation, testing for compliance with specifications, automated mixture optimization, and manufacturing processes in the construction industries. A relational database is provided with linked objects to create both standards-based and manufacturer-based specifications for concrete and concrete constituent materials. Concrete recipes utilizing the defined specifications are developed either prescriptively or performance-based. Standards-based base mixes that specify concrete can be instantiated into production mixes using local materials.

U.S. Pat. No. 6,826,498 to Birkner et al. and assigned to the assignee of the instant application discloses a computer-implemented system performs quality control on a construction material mixture by accessing a server located on a wide-area-network; sending information collected from the material mixture to the server; applying one or more test methodologies to the collected information; generating one or more reports from the test methodologies; and sending the one or more reports to a project manager.

### SUMMARY

A facility control system includes lab equipment with a wireless transceiver to transmit machine generated actual initial measurement (AIM) data from a field test to a wide area network; a mobile computer with a wireless transceiver to transmit human generated data from an office, a remote lab, or a field test to the network; and a server coupled to the network, the server including a database to receive machine and human generated AIM data, wherein the server applies statistics and engineering methods to predict specification compliance and performance, wherein the AIM data is used with pre formatted engineered designed data sheets that reflect the required standards and best practices including incorporating best construction practices for installation of one or more construction items and materials quality to promote standardization, uniformity that insures contract compliance and minimizes non-conforming items, wherein the AIM and actual final measurement (AFM) data is calculated on the server over the network in real time, wherein the server, lab equipment, and mobile computer form a systematic approach to provide real time dynamic reports regarding one or more components of a capital improvement program (CIP) or similar; wherein the systematic approach enables one or more construction teams to generate dynamic reports in real time with best practice engineered designed data sheets for installation and testing of project activities and construction items, and wherein the systematic approach supports indexing of complete project specific data to facilitate document retrieval and project collaboration.

Advantages of the preferred embodiments may include one or more of the following. The final data can be computed and shared with all project team members using the WAN. The FCS is a systematic approach for multiple projects, regardless of their stage in the life cycle process including but now limited planning, design, construction, operation, maintenance, inspection, testing laboratories and various processes and manufactured construction materials real time on the project cost, schedule, and quality assurance. The status of a given project activity, including cost, schedule and quality can be determined in real time and be shared among all project team members. The system provides a complete view from all sources of data including AIM data collected by a human operator or laboratory, field and/or construction equipment. Such information links the entire management, engineer and construction team by use of a computer mobile or stationary that have been formatted with “raw” data sheets which have been designed to collect initial data that conforms to industry best practices such that contract compliance with required project standards is determined, management reports are readily available, dynamic reports can be viewed by the entire team in real time. The pre-engineered raw data sheets formatted for best practices are designed to be indexed in a manner that facilitates expedite quick and accurate retrieval and collaboration between all team members.

The system allows AIM and AFM to be calculated in a WAN in real time. The AIM data pre formatted data sheets incorporate best engineering and construction practices for installation and materials quality to promote standardization, uniformity and insure contract compliance and minimize the occurrence of non-conforming items. In addition, the FCS approach implements a preventative systematic approach to minimize the effort in final project commissioning. Furthermore, the AIM checklist can be are formatted on a mobile device or another other type of computer to facilitate the rollup of field data and all sources of data that occurring throughout the construction team various site office and other project locations.

The AIM engineered designed best practices standard forms are designed such that the data collected results in compliance with industry best practices and in addition to specification compliance. The use of “raw” pre-engineered best practice data sheets formatted for a human to enter data directly on a GIS map enables accurate 3D locations and associated data.

Potential Sources of AIM Data may include:

1. Data directly entered into a GIS map with pre formatted data sheets

2. Data from Office Engineer/Project Manger desk top computer

3. Planning, Design and Construction managers and engineers, technicians and administrators use of a computer

4. Construction testers and inspectors use of computers with preformatted engineered designed “raw” data sheets that encourage best practices in the industries such that “real time” status is determine, contract compliance, non-conformance items is also minimized

5. Laboratory equipment and construction field equipment are also a source of AIM data

6. Operations can also transfer AIM data directly into a WAN

7. Maintenance operations can also transfer AIM data directly into a WAN

8. Photographs, Video clips. Sketches of current site conditions

9. Data entered using a mobile field device

The AFM can be calculated according to industry standards and/or management preferences. The AFM dynamic reports have been validated, presented in best practices format and available in real time. The indexed AFM reports are dynamic and provide “true” real time status reports. The AFM reports can also be viewed in a GIS Map that permits the instant retrieval of “raw” AIM data. The Indexed AFM data provides a list of daily activities, dynamic reports, list of active NCR and initiates the NCR report process. The AFM data is used to determine compliance with project design, construction, operations and maintenance requirements, cost control, schedule control and regularity compliance. The data viewing rights are controlled in the system. The AFM are also presented on pre-design dynamic performance reports that allow trending and provide the manager the ability to avoid non-conformance and costly re-work. Alarming trends or non-conformance would be available to the management team in “true” real time. The results can be posted by the use of GIS map and facilitate data retrieval and analysis. In addition, since the AIM data is easily retrieved in the index system the resolution and management response and appropriate action is easily addressed. The data includes engineering data, photographs and video of actual conditions. Access to all data assist in providing a real time evaluation of the actual facility. The construction team has a dynamic environment that permits viewing of selected data and reports in “true” real-time. The current state of the art is linear viewing with many point to point interruptions (silos), rather than an integrated solution with real time information that has been designed to regulate inflow, outflow and final indexing.

The use of GIS pre-engineered best practiced “raw” data sheets allow the results to be viewed on a GIS map with exact coordinates. There the AIM and AFM data, reports are clearly identified by their respective locations. This feature provides a unique efficient systematic approach to reviewing final data and its supporting documentation. This feature will also provide improved characterization of site conditions for future design and construction projects.

The AIM data is input and AFM data is calculated in the WAN and readily available to the program mangers and various project team members. In addition, the filing of the final data is pre indexed which facilitate retrieval and allow dynamic viewing that is being able to view the specific report or item at your convenience via the internet. The data includes engineering data, photographs and video of actual conditions. Access to all data assist in providing a real time evaluation of the actual facility. The construction team has a dynamic environment that permits viewing of selected tops and details related in “true” real-time. The current state of the art is linear viewing with many point to point interruptions (silos), rather than an integrated solution.

### BRIEF DESCRIPTION OF THE DRAWINGS

FIG. 1 shows an exemplary construction management process system.

FIG. 2 illustrates an exemplary process for collecting actual initial measurement (AIM) data.

FIG. 3 illustrates the use of preplanning forms in the FCS.

FIG. 4 shows an exemplary web Mapping in the FCS.

FIG. 5 shows exemplary phases of activities for installation of checklists.

FIG. 6 illustrates exemplary major phases of activities for a punchlist.

FIG. 7 shows FCS in an asphalt hot mix laydown operation example.

FIG. 8 shows an exemplary file storing FCS Engineered Raw Data Sheet with Best Practices.

FIGS. 9A-9C show an exemplary process algorithm to provide program and/or portfolio facility control system for real time management of each components.

### DESCRIPTION

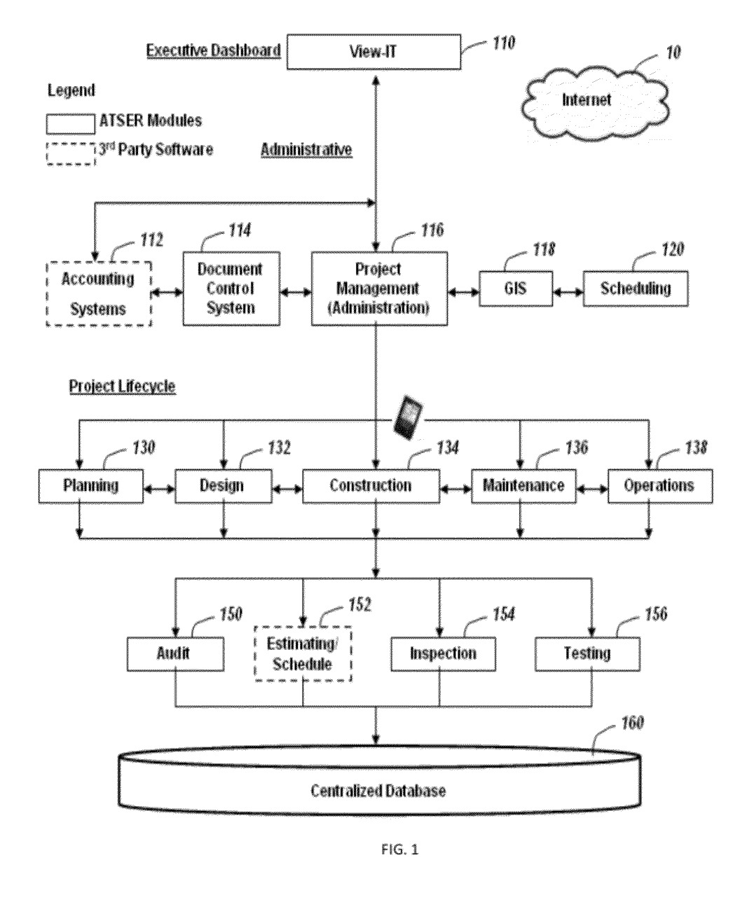

FIG. 1 shows an exemplary construction management process system that communicates over the Internet 10. The system provides an integrated solution that provides one silo for all the data functions and will allow for quick retrieval of real-time data. This will increase operational efficiencies by removing latency in the work flow processes.

The system has a management dashboard 110 that allows for quick retrieval of key indicator data allowing managers to view real-time data on their projects and drill down to the details. The dashboard 110 communicates with an accounting system 112 and a project management system 116. The project management system 116 in turn communicates with a document control system 114. The control system 114 provides indexing and filing of projects and program documents. The proper retrieval for claim management enables the agency or project owner to properly manage its contractors' claims. The project management system 116 also communicates with a geographical information system (GIS) 118, which in turn communicates with a scheduling module or system 120.

The project management system 116 has modules that handle different phases of each project. One module is a planning module 130 where Owner/Agencies can plan for a number of projects. The planning phase can be very detailed and be associated with financial plans. These records are maintained for expediting future planning efforts. Another module is a design module 132. The design module 132 allows designs to be maintained. Agencies often subcontract design to third party companies which maintain dissimilar reporting capabilities, further exasperating the goal of real-time and standardized reporting.

Another module is a construction module 134. Construction activities are complex and exhaustive in administrative details. Construction work may or may not be tied to plans developed by a third party. The Owner wants to disperse payment for work in accordance with approved contract documents. The work often includes many subcontractors and vendors. The additional parties make the process much more difficult to administrate field changes and conflicts in the documents.

Another module is a maintenance module 136, which tracks agencies' maintenance requirements which can be complex. The parameters that trigger maintenance are very complex concepts. The problem is exasperated since sophisticated equipment connecting to systems is needed to make maintenance decisions.

Yet another module is an operations module 138. Agencies/Owners implement complex operation parameters. These operations requirements are audited by agencies and/or contractors. The operations roll-up often requires connections with complex equipment.

The management system also includes an audits compliance module 150. Agencies enter into complex contract documents that have specific requirements for compliance. Almost always the agency does not have an efficient system to verify complex concepts in the various stages of project delivery. The system must be able to roll up, evaluate, and audit project delivery phases of compliance simultaneously. The evaluation and audit allow agencies to approve segment of work and recommend payment. The contract audit compliance is used for project verification of contract requirements, among others.

An estimating/scheduling module 152 communicates with the project management system 116. This module enables users to generate estimates of time and material costs for a particular project.

An additional module communicating with the project management system 116 is an inspection module 154. The inspection process is designed to determine the compliance of the contract documents with projects have many construction items with specific and unique items. It has proven beneficial to develop checklists that outline the important actives that should be verified to insure compliance. The module enables users to communicate design, construction, maintenance and operational nonconformance in real time as to minimize the occurrence of non conformance materials and workmanship.

Another module is a testing module 156. Agencies require testing services. These services usually are performed by agencies, third party companies, and/or contractors. The information is detailed and specific to various construction items.

The information captured or generated by modules of FIG. 1 is stored in a central database 160. The system can communicate with mobile computers and devices as well. For example, PDAs, smart phones, laptops, and tablet PCs are supported. Through an electronic interface, the system interfaces with lab equipment and other peripheral devices such as OCR scanners and PDAs across the Internet. The system also communicates with Lab Equipment through custom interfaces built between laboratory scales, ignition ovens, concrete break machines, and equipment to measure confined and un-confined compressive strength, among others.

The system of FIG. 1 is a complex integrated system that is interconnected with lab equipment and portable devices such as PDAs. The system supports one data silo for all data to allow for quick retrieval of data in real-time. The system uniquely combines all Planning, Design, Construction, Maintenance, and Operations activities into one silo that allows for roll-up of data to provide real-time key indicators on phases of a project. The Management Dashboard 110 allows a quick retrieval of key indicator data allowing managers to view real-time data on their projects and drill down to the details. The Document Control System 114 supports indexing and filing of projects and program documents. The proper retrieval for claim management is critical to defending the owner against contractor's claims. The planning module 130 enables highly detailed planning that can be associated with financial plans. The system maintains these records for expediting future planning efforts. The Design module 132 enables agencies to subcontract design to third party companies which maintain dissimilar reporting capabilities and furthering the goal of real-time and standardized reporting. Construction work may or may not be tied to plans developed by a third party. The Owner wants to disperse payment for work in accordance with approved contract documents. The work often includes many subcontractors and vendors. The additional parties make the process much more difficult to administrate field changes and conflicts in the documents. The Construction module 134 handles construction activities which are complex and exhaustive in administrative details.

The maintenance module 136 tracks agency's maintenance requirements which can be highly complex. The parameters that trigger maintenance are very complex and detailed. The problem is exasperated since sophisticated equipment connecting to systems is needed to make maintenance decisions. The maintenance module enables agencies to manage their maintenance requirements.

The operations module 138 enables Agencies/Owners to implement complex operation parameters. These operations requirements are audited by agencies and/or contractors. The operations roll-up often requires connections with complex equipment. The inspection module 154 is designed to determine the compliance of the contract documents with approved plans. Often projects have many construction items with specific and unique items. It has proven beneficial to develop checklists that outline the important actives that should be verified to insure compliance. It is important to communicate design, construction, maintenance and operational nonconformance in real time as to minimize the occurrence of non conformance materials and workmanship, and the system of FIG. 1 supports such real-time communications.

The system also handles testing services required by Agencies. These services usually are performed by agencies, third party companies, and/or contractors. The information is detailed and specific to various construction items. The system interfaces with lab equipment and other peripheral devices such as OCR scanners and PDAs across the Internet. The system also communicates with Lab Equipment through custom interfaces built between laboratory scales, ignition ovens, concrete break machines, and equipment to measure confined and un-confined compressive strength, among others.

The system also provides Audits Compliance through the audit module 150 and other modules. Agencies enter into complex contract documents that have specific requirements for compliance. Almost always the agency does not have an efficient system to verify complex concepts in the various stages of project delivery. The system must be able to roll up, evaluate, and audit project delivery phases of compliance simultaneously. The evaluation and audit allow agencies to approve segment of work and recommend payment. The contract audit compliance is needed for project verification of contract requirements.

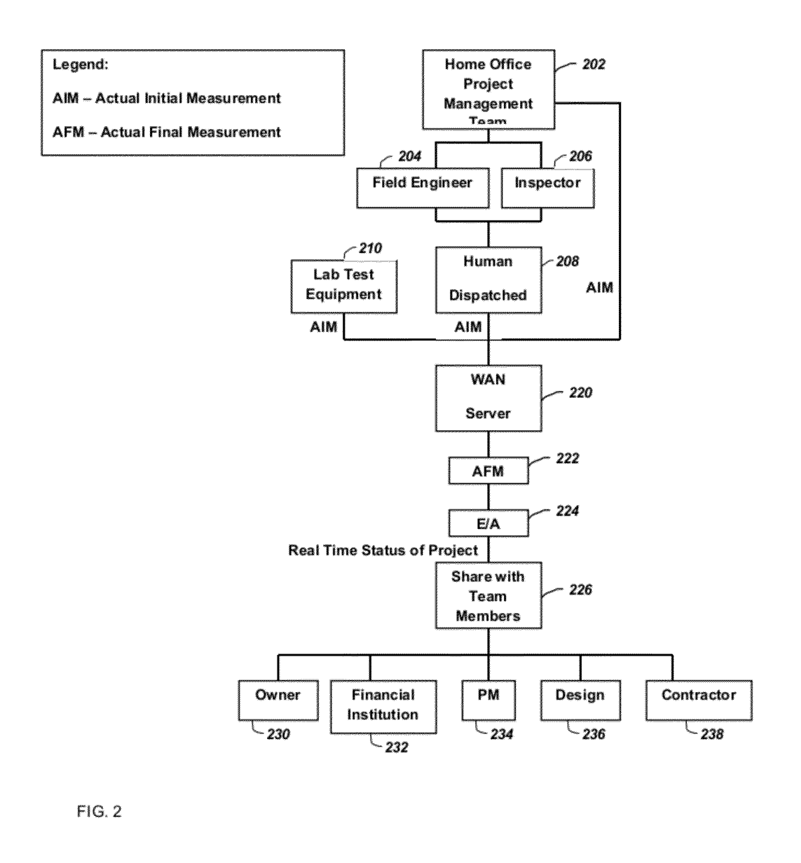

FIG. 2 illustrates an exemplary process for collecting actual initial measurement (AIM) data. The FCS permits “real time” control such that the project administration, cost, schedule, quality, work, workmanship and testing can be controlled. Basically, the home office needs are planned and documents using standard data sheets placed on a mobile computer. The preplanned forms communicate project needs, implement best practices and enable compliance with appropriate specifications as required by the contract documents. The data information is collected in real-time for a project in the field. The information is critical to make timely and cost effective decisions.

Turning now to FIG. 2, a home project management team is assembled (202). The team selection process includes selecting field engineers (204) and inspectors (206). People are dispatched to the field (208). In addition, lab test equipment is dispatched to the field (210) to collect AIM data. The AIM data and human collected notes and materials are sent to a database in a server located on a network such as the Internet (220). The database also captures actual final measurements (AFMs) (222). Engineering and Statistical analysis (E/A) is performed (224). The information is shared among team members in real-time (226). The information can be shared with project owner (230), financial institutions (232), project managers (234), designers (236), and contractors (238), among others.

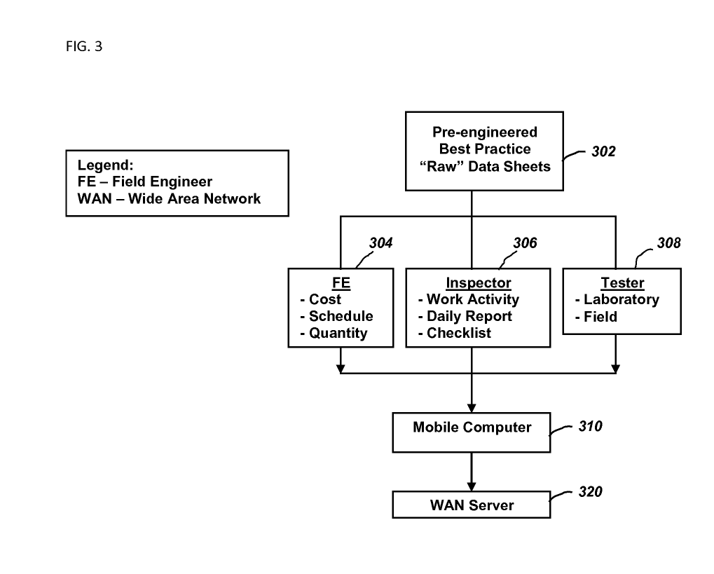

FIG. 3 illustrates the use of preplanning forms that outline the activities required and for “outfitting” the mobile computers for use by personnel dispatched to the field such as the field engineer, inspector and testers. The home office needs accurately and timely information to manage the project in the field, conduct required inspection and testing, verify qualities, update the budget based on work performed, update the schedule and document required administrative details. The use of mobile computers equipped with preplanned forms and data sheets will facilitate the required work, verify construction activities complied with contract documents, implement “best practices” for construction supervisors, and provide checklist that outline “how to” such that work can be verified. The forms could include for field engineers involve administrative, cost, schedule and quantity. The forms for inspectors relate to work activity, daily report and checklist. The forms for equipment testers cover laboratory and field tests. The testing forms can also be connected to laboratory equipment to record AIM data. Then all collected data from different forms are then transmitted via the internet (wired or wireless) and shared to all project team members by use of a WAN. These preplanning “best practice” forms are also application to all stages of the life cycle.

Referring now to FIG. 3, preplanned forms are generated (302). A field engineer can use the pre-planned forms to capture cost, scheduling, and usage quantity, for example (304). An inspector can use his custom forms to capture work activity, daily reporting, and completing checklists, among others (306). A tester can use his/her custom forms to capture laboratory information and field test information, among others (308). The information is entered into a mobile computer (310). The computer in turn uploads information to a server on a WAN such as the Internet (320).

The system permits project manager to plan through the use of standard forms placed on the mobile computer before dispatching the field engineer, inspectors and testers. The system thus allows project managers to plan their required activities before being dispatched to the project site. This planning step and the implementation of this information to a mobile computer allows all parties to receive the information in real time and enable timely decisions from the main office. The standardization of forms enables the field personnel to quickly conduct the required tasks in the field and report them through the internet (wired or wireless) and have the field results available for team members in real time. The data collected is “raw” or actual initial measurements. The source of the “raw” or AIM data is from human and or directly from laboratory equipment. The mobile computers have been pre-formats with forms that outline the project requirements. The final data (AFM) is calculated in the server and is readily available for engineering and statistical analysis. The data is available on a WAN for project members with viewing rights. The viewing members can include owners, engineers, project managers and financial institutions, among others.

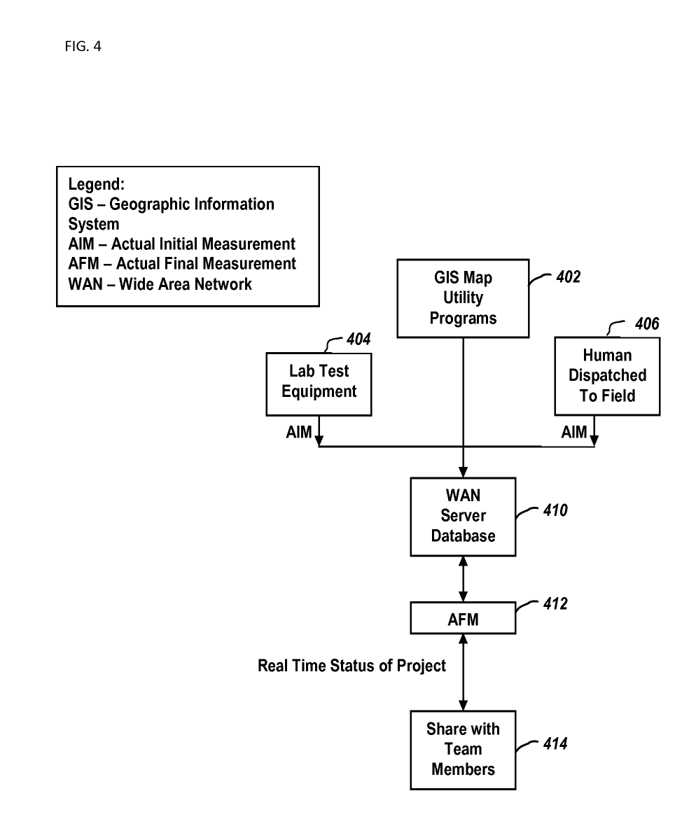

FIG. 4 shows an exemplary Web Mapping process in the FCS. Web geographic information system (GIS) Mapping is used to update and manage field activities for project personnel. Information is dispatched from the FCS and the information is displayed on the GIS Map Component in real time and on a mobile field device (PDA, laptop PC . . . etc) through a wireless connection.

FIG. 4 illustrates the process of Web GIS Mapping (Visualization Component) in the Facility Control System. A GIS utility application is started (402).

The lab test equipment can transmitted its GIS coordinate along with AIM information and other results to the server database (404). Similarly, humans dispatched to the field can generate reports on their mobile computers and such results can be annotated with GIS location information (406). The GIS data, along with AIM information and human reports, are received and stored at the server database (410). The server 410 can store the information with the AFM and can also annotate the AFM with GIS location information (412). All information can be shared among team members in real time (414).

The project personnel can view the activities on the GIS Map Component and update the information directly on the GIS Map and the data can be viewed and reviewed by project personnel within the FCS. Web GIS Mapping utilizes the real time data from the WAN Server database to update the job site status, activities, and location. The user can view a history of events that occurred at the site on the GIS Map. The GIS Map and FCS are an integrated database platform that allows data to be entered through the GIS Map interface of the FCS interface. Web Mapping also makes use of the GIS map embedded with a certain platform and utility programs to pin point the project sites. The visualization of web mapping let the project managers, engineers, testers and field inspectors easily locate the specific jobsites to perform the work and lets them know what work needs to be performed in real time.

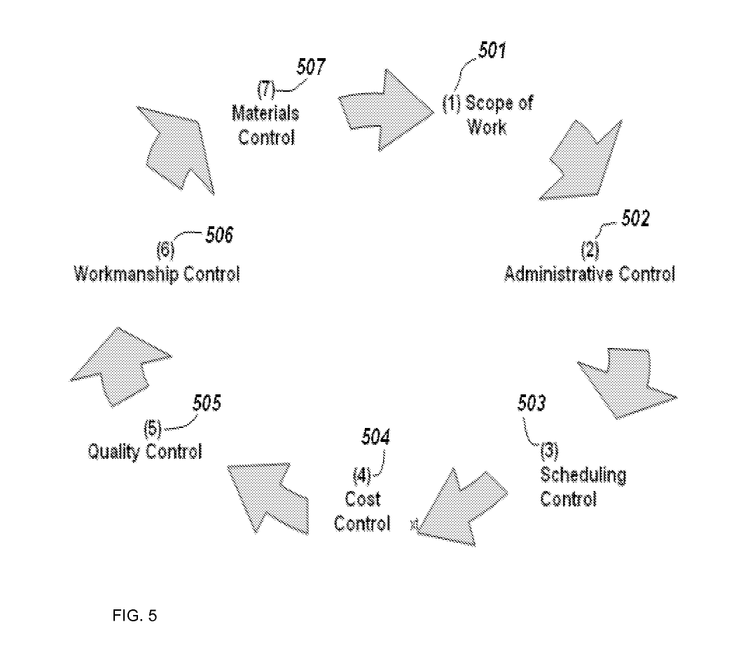

FIG. 5 shows exemplary phases of activities for installation of checklists. The project manager at the central office requires updates from the field for overall project control. The seven phases of work for checklists which are prospective and include the following:

Scope of Work (501)

Administrative Control (502)

Scheduling Control (503)

Cost Control (504)

Quality Control (505)

Workmanship Control (506)

Materials Control (507)

The use of activity data sheets preformatted on mobile computes allows the field personnel to review Work in real time, as opposed to reviewing Work that is completed. FCS permits to review the orderly progress of the Work, identify upcoming activities, outfit the mobile computers with the instructions for dispatched personnel, and permit the collections of project information. FCS also permits real time control of all field project activities. The construction superintendent can also make use of the system to outline this week activities and insure they have been completed and constructed use “best practices”, maintain records of completion and comply with contract documents.

The Checklist portion of FCS is a tool to help ensure the required Work is performed, and performed in the most efficient sequenced and once completed meets contract requirements and intended Quality. The FCS permits the project manager and/or the Superintendent to dispatch its field representatives to control work, scheduling of work, cost of work, quality of work and required administration functions.

A Checklist portion of the FCS also enables planning of required tasks, their sequencing and permits compliance verification during actual activity. Essentially a Task List, is generated which identifies items that must be performed and in their proper sequence. As this items are preformed the administrative, cost, schedule and quality are monitoring in real time and reported to central office to maintain overall control of the project.

In one embodiment, the Checklist portion of the FCS effort is prospective in that it is an implementation and consideration of the most efficient sequence of the required work. In addition, the checklist provides “how to” implement the required work and facilitates the implementation by using best practices. The impact of this optimal task sequencing on the work, schedule and quality is monitored in real time. The Checklist feature also acts as a verification of project quality.

A Punchlist is a list of items after Work has been completed and itemizes the items that have not been performed as required and/or constructed such that the work does not comply with contract documents requirements, which did not meet specifications or desired Quality. A punch list is a static document which is generally a list of tasks or “to-do” items that must be remedy before the project is accepted by the buyer. A punch list is retrospective in the sense it is a review of work already completed and notes tasks remaining or deficiencies with work already completed.

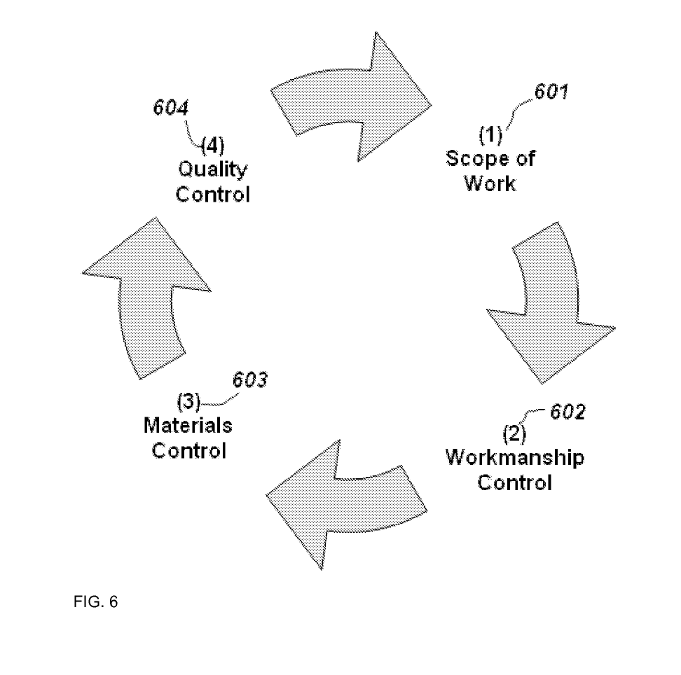

FIG. 6 illustrates exemplary major phases of activities for a punchlist. The punch list is a task list of the items that must be corrected and/or completed before receiving final approval. The punchlist focuses on identifying work that is not completed or deficient and is always retrospective. The figure illustrates that a punchlist only considers four activities phases, retroactively:

Scope of Work (601)

Workmanship Control (602)

Materials Control (603)

Quality Control (604)

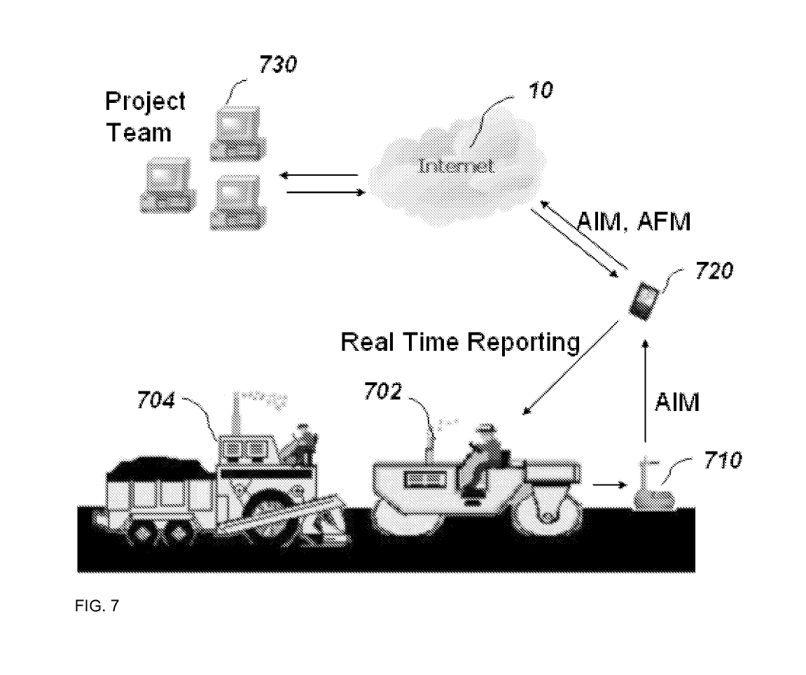

FIG. 7 shows FCS in an asphalt hot mix laydown operation example. One of examples applied to FCS process is the hot mix laydown operation. During the hot mix laydown operation, the nuclear gauge takes shots for the compaction density. The hand-held mobile device connected to the nuclear gauge receives the AIM, and send the AIM and AFM to the project team's computers via the internet (wired or wireless) in real time. Thereby the project team receives real-time specification compliance and status.

One of examples applied to FCS process is the hot mix laydown operation. FIG. 7 shows an asphalt hot mix laydown operation example. In this example, trucks 702-704 lays down asphalt hot-mix. During the hot mix laydown operation, equipment 710 such as a nuclear gauge takes shots for the compaction density of the asphalt. A hand-held mobile device 720 connected to the nuclear gauge equipment 710 receives the AIM, and send the AIM and AFM to the project team's computers via the internet 10 over wired or wireless transmissions in real time to team computers 730. Thereby the project team receives real-time specification compliance and status.

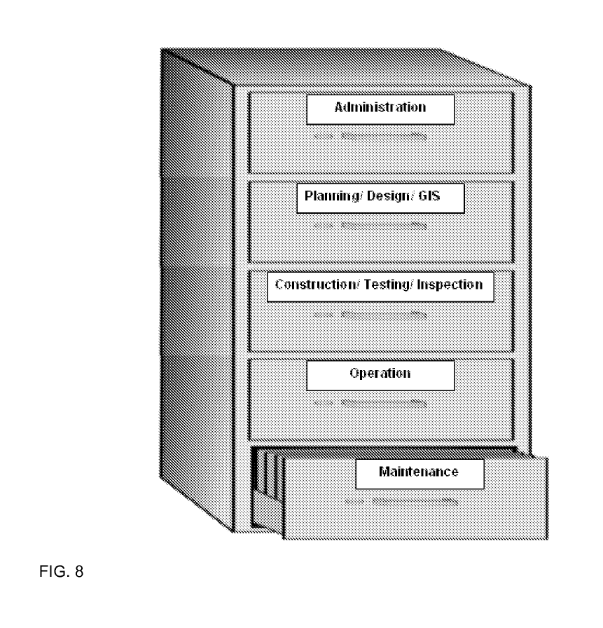

FIG. 8 shows the indexing of FCS making use of “raw” data sheets engineered designed for each project activity and construction item. Dynamic reports for each component of the CIP life cycle index in accordance with best practices engineered raw data sheets. A systematic approach to log AIM and AFM data, produce dynamic reports of infinite projects within the life cycle of a CIP Program. The benefits of indexing are quick data retrieval, facilitating communication between project team, provides a list of daily activities “to do”, list of NCR to address and initiate NCR reports. This dynamic reporting minimizes the occurrence of non-compliant activities taking place throughout the program.

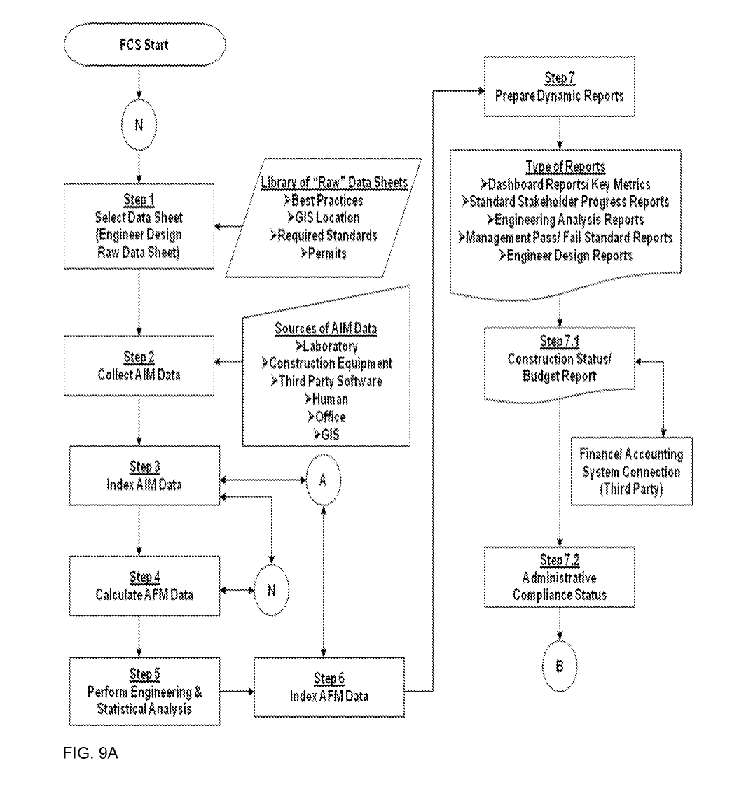

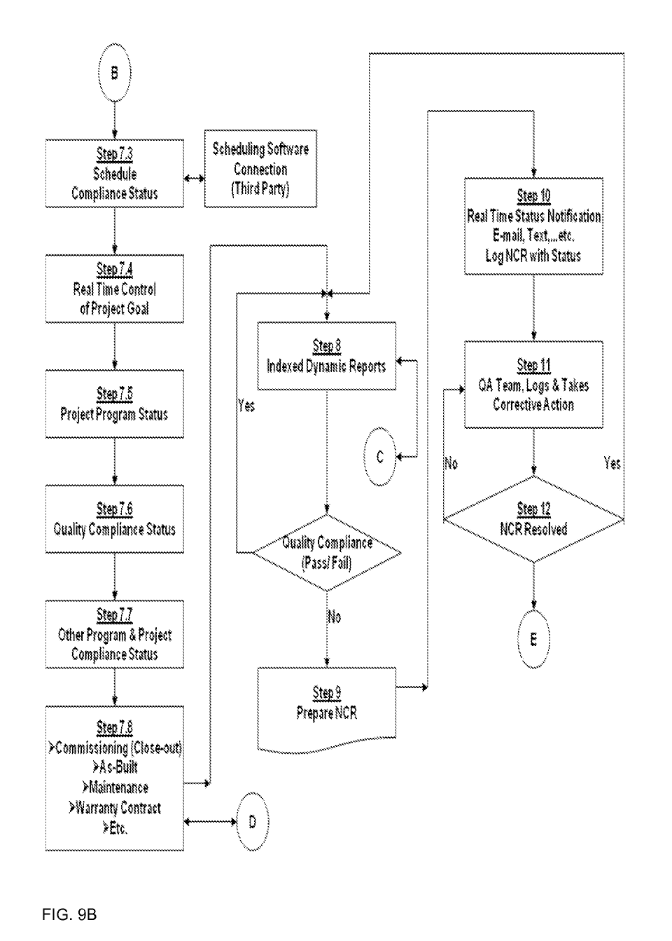

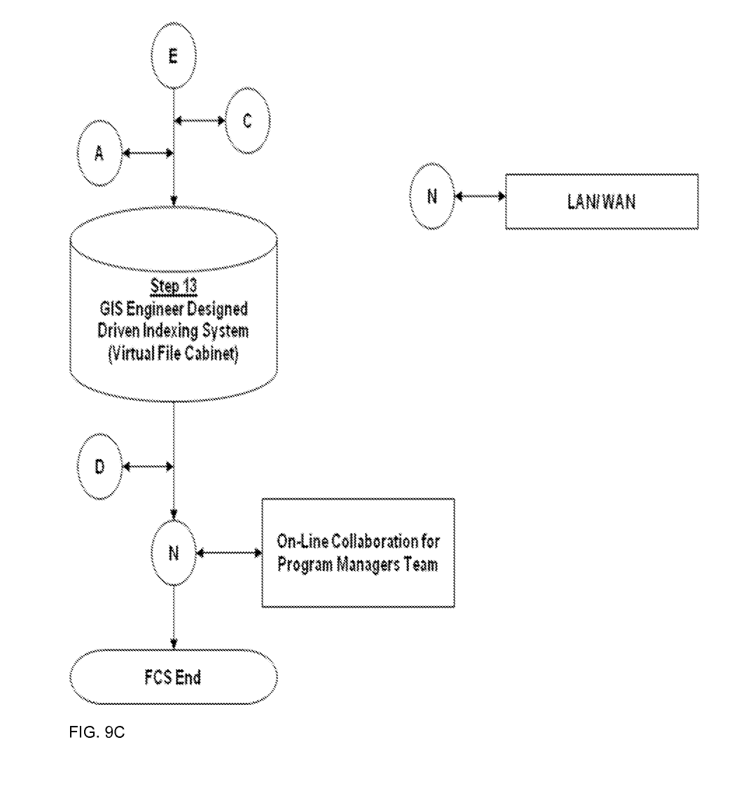

FIGS. 9A-9C show an exemplary process to provide construction management. From the start of the FCS process, the process selects data sheets such as engineering design raw data sheets, for example (step 1). For example, a library of raw data sheets can guide users as to best practices, GIS locations, required standards and permits, among others. Next, the process collects AIM data (step 2) from sources such as lab data, construction equipment, third party software, people, office data, or GIS systems, among others. The AIM data is indexed (step 3) and processed (step 4). Next, the process performs engineering and statistical analysis (step 5).

The AFM data is indexed (step 6). Dynamic reports can be generated (step 7). The types of reports can include dashboard reports, metrics, progress reports, engineering analysis reports, and engineering design reports, among others.

The process can generate construction status or budget reports from finance/accounting systems or third party systems (step 7.1). The process can also check on administrative compliance status (step 7.2). The process can check on schedule compliance status (step 7.3) by connecting ton internal database or a third party scheduling software, for example. Next, the process can perform real time control of the project goal (step 7.4). Project program status can be determined (step 7.5). Quality compliance status can be checked (step 7.6). The process can also check other program/project compliance status (step 7.7). The project can also perform commissioning (close out) and check as built condition, maintenance and warranty contractual obligations, among others (step 7.8).

The process can index dynamically generated reports (step 8). Next, the process checks for quality compliance. The process prepares an NCR (step 9) and provides real time status notification through email, texting, among others (step 10) as well as logs the NCR with the status. Next, the process updates data for the QA team, the logs so that corrective action can be taken (step 11). The process checks if the NCR has been resolved (step 12) and once loops back to step 11 to resolve the problem and otherwise loops back to step 8.

FIG. 9C shows an exemplary database that receives data from connectors A, E, C of FIGS. 9A-9B and stores GIS engineer designed indexing system (step 13). This is the virtual file cabinet of FIG. 8. The virtual cabinet can support connectors D and N for on-line collaboration of the teams, among others.

By way of example, a block diagram of a computer to support the automated chip design system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer). Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A facility control system, comprising:
a lab equipment with a wireless transceiver to transmit machine generated actual initial measurement (AIM) data from a field test to a wide area network;
a mobile computer with a wireless transceiver to transmit human generated data from an office, a remote lab, or a field test to the network; and
a server coupled to the network, the server including a central database to receive machine and human generated AIM data, wherein the server applies statistics and engineering methods to predict specification compliance and performance, wherein the AIM and AFM data is used with pre formatted engineered designed data sheets and dynamic reporting that reflect required standards and best practices including incorporating best construction practices for installation of one or more construction items and materials quality to promote standardization, uniformity that insures contract compliance and minimizes non-conforming items, wherein the AIM and AFM data is calculated on the server over the network in real time,
wherein the server, lab equipment, and mobile computer form a systematic approach to provide real time dynamic reports regarding one or more components of a capital improvement program (CIP); wherein the systematic approach enables one or more construction teams to generate dynamic reports in real time with best practice engineered designed data sheets for installation and testing of project activities and construction items, and wherein the systematic approach supports indexing of complete project specific data to facilitate document retrieval, project collaboration and the roll-up of the various projects in a program and or a portfolio.

2. The system of claim 1, wherein final data is calculated on the server and shared with project team members over the network.

3. The system of claim 1, wherein the server stores data in the central database for monitoring multiple projects or programs, regardless of their stage in the life cycle.

4. The system of claim 1, wherein the server stores data relating to planning, design, construction, operation, maintenance, inspection, testing laboratories and various processes and manufactured construction materials real time on the project cost, schedule, and quality assurance.

5. The system of claim 1, wherein the status of a given project activity quality can be determined in real time and be shared among all project team members.

6. The system of claim 1, comprising a integrated project management module coupled to a centralized database.

7. The system of claim 6, comprising:
a document control system;
an accounting system;
a scheduling system; and
a geographical information system (GIS).

8. The system of claim 6, comprising a planning module, a design module, a construction module, a maintenance module, and an operations module.

9. The system of claim 6, comprising an audit module, an estimating/scheduling module, an inspection module, and a testing module.

10. The system of claim 1, wherein the database captures actual final measurement (AFM).

11. The system of claim 1, wherein the statistics and engineering methods comprise aggregate, asphalt, concrete and soil tests and all types of construction materials.

12. The system of claim 1, comprising a plurality of pre-formatted forms stored in the mobile computer.

13. The system of claim 12, comprising a field engineering form to capture a cost, a schedule, labor, equipment and a quantity.

14. The system of claim 12, comprising an inspector form to capture a work activity, a daily report and a “checklist” designed with consideration of required standards, indexing logs and consideration of best practices installation report.

15. The system of claim 12, comprising a tester form to capture laboratory and field test data.

16. The system of claim 1, wherein the database stores GIS data along with AIM data or human generated field data.

17. The system of claim 1, wherein the server runs a preventative systematic checklist to minimize final project commissioning.

18. The system of claim 1, wherein the checklist is formatted on a mobile device to facilitate a rollup of field data and other sources of data occurring throughout the construction team, one or more site offices, and one or more project locations.
